(19) United States
(12) Patent Application Publication
(10) Pub. No.: US 2006/0206333 A1
(43) Pub. Date: Sep. 14, 2006

(54) Speaker-dependent dialog adaptation

(75) Inventors: Timothy S. Paek, Sammamish, WA (US); David M. Chickering, Bellevue, WA (US); Eric J. Horvitz, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/170,998

(22) Filed: Jun. 29, 2005

Related U.S. Application Data
(60) Provisional application No. 60/659,689, filed on Mar. 8, 2005.

(51) Int. Cl. G10L 13/00

(52) U.S. Cl. 704/260

(57) ABSTRACT

A simulation environment for adapting a speech model (e.g., baseline model) to a user is provided. The user can interact with a base parametric speech model (e.g., statistical model with learnable parameters such as a Bayesian network) and give positive and/or negative feedback when the dialog system has performed what the user considers to be appropriate and/or inappropriate action(s). From the user feedback, the dialog system learns to take actions customized for the particular user. Speaker-dependent adaptation can be extended to the dialog level by performing maximum likelihood linear regression (MLLR) adaptation simultaneously with dialog personalization. Users are immediately able to observe how their feedback has caused the dialog system to adapt, and can quit training whenever they feel that the dialog system has adapted enough for current purposes.

### REFERENCE TO RELATED APPLICATIONS

This application claims the benefit of U.S. Provisional Application Ser. No. 60/659,689 filed on Mar. 8, 2005, and entitled SYSTEMS AND METHODS THAT FACILITATE ONLINE LEARNING FOR DIALOG SYSTEMS, the entirety of which is incorporated herein by reference.

### BACKGROUND

Human-computer dialog is an interactive process where a computer system attempts to collect information from a user and respond appropriately. Spoken dialog systems are important for a number of reasons. First, these systems can save companies money by mitigating the need to hire people to answer phone calls. For example, a travel agency can set up a dialog system to determine the specifics of a customer's desired trip, without the need for a human to collect that information. Second, spoken dialog systems can serve as an important interface to software systems where hands-on interaction is either not feasible (e.g., due to a physical disability) and/or less convenient than voice.

Spoken dialog systems utilize speech recognition engines. Generally, speech recognition engines are typically shipped with the “average” user in mind—that is, with generic, speaker-independent model(s). Many speech application environments offer simple training wizards to “personalize” the engine to a user's particular voice. These wizards usually involve reading text aloud, from which sound samples are obtained for speaker-dependent maximum likelihood linear regression (MLLR) adaptation of acoustic and pronunciation models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A simulation environment for adapting a speech model (e.g., baseline model) to a user is provided. A user can employ a user adaptation system to personalize a dialog system. In this manner, the user can interact with a base parametric speech model and give positive and/or negative feedback when the dialog system has performed what the user considers to be appropriate and/or inappropriate action(s). From the user feedback, the dialog system learns to take actions customized for the particular user.

Speaker-dependent adaptation can be extended to the dialog level by performing MLLR adaptation simultaneously with dialog personalization. Similar to MLLR adaptation, user(s) can end training at any time with the notion that the more they train, the more customized the dialog system becomes. Unlike conventional MLLR adaptation; however, users are immediately able to observe how their feedback has caused the dialog system to adapt, and can quit training whenever they feel that the dialog system has adapted enough for current purposes.

Thus, with the simulation environment, a user can improve both the interaction and speech recognition by giving feedback about the appropriateness of actions taken by the dialog system while at the same time allowing the system to collect sound samples for MLLR adaptation. In addition to training a speaker-dependent speech model for recognition, a user can train the dialog system to take better dialog actions and recognize utterances better for a particular dialog domain.

The simulation environment can employ a dialog system that utilizes parametric speech models (e.g., statistical model with learnable parameters such as a Bayesian network) and a language model specifying the utterances that can be spoken in the particular domain. A user interface component can sample an utterance from the language model and presents it to the user (e.g., via a display). The user's task is to read the utterance. Optionally, the user interface component can introduce various kinds of visual and auditory noise as the user reads the utterance (e.g., for training purposes). Adding noise can spur speakers to produce utterances of varying nuances, which is useful both for MLLR adaptation and for dialog action selection.

After the user reads the utterance, the dialog system attempts to recognize what was said and respond accordingly. When the dialog system responds, the user can give positive or negative feedback which is used to update a utility model. When the user gives positive feedback, the system infers that the utility of the action taken should be high. Likewise, when the user gives negative feedback, the system learns that the utility of the action taken should be low. Various kinds of user interfaces can be developed to allow users to give feedback that is binary or graded along a scale. User interfaces can also be developed to give feedback for 1) specific system actions, 2) sequences of actions, or 3) types of actions, depending on how the underlying utility model is to be updated. In other words, in one example, the system can learn that 1) taking a specific action A when features, P, Q, and R are present has low utility, 2) taking action sequence A-B-C always has low utility, or 3) taking any action of Type(A) has low utility (e.g., any confirmations regardless of circumstance).

Once the dialog system either receives negative feedback or positive feedback (explicit or implicit), and when an end dialog state has been reached, the dialog system can view the correct answer(s) via the adaptation component. By observing the correct answer(s), the dialog system can build case data for supervised learning of the form: “User said X. I heard Y with features P, Q, and R.” Parameters of the speech model can be based on the learning data.

As the user continues to interact with the dialog system in the simulation environment, more and more data cases can be used for supervised learning, reinforcement learning, and MLLR adaptation. The user can continue to train the dialog system however long they wish knowing that the more they train, the more customized the dialog system will be to the user. In other words, they can personalize the dialog system to achieve speaker-dependent performance at both the recognition level and dialog level.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features of the claimed subject matter may become apparent from the following detailed description when considered in conjunction with the drawings.

### BRIEF DESCRIPTION OF THE DRAWINGS

FIG. 1 is a block diagram of a simulation environment

FIG. 2 is a flow chart of a method of training an online learning system.

FIG. 3 is a flow chart of a method of adapting the speech and utility model to a user.

FIG. 4 illustrates an example operating environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

Conventional speech recognition environments offer simple training wizards to “personalize” the engine to a user's particular voice. These wizards usually involve reading text aloud, from which sound samples are obtained for speaker-dependent maximum likelihood linear regression (MLLR) adaptation of acoustic and pronunciation models.

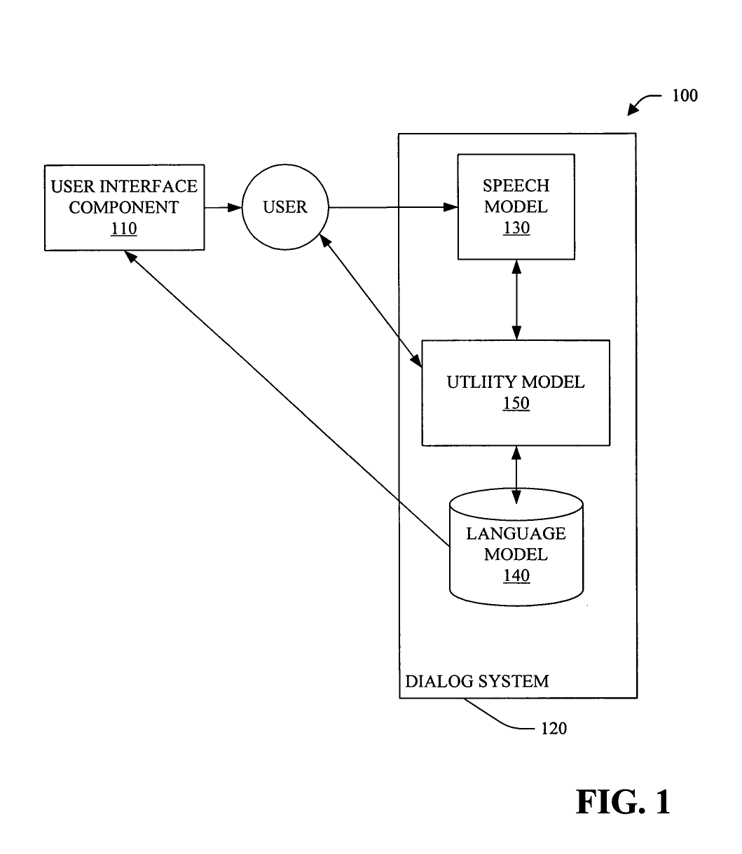

Referring to FIG. 1, a simulation environment 100 is illustrated. For example, the simulation environment 100 can be employed to adapt a baseline speech model to a particular speaker.

With the simulation environment 100, a user can employ a user interface component 110 to personalize a dialog system 120. In this manner, the user can interact with a base parametric model, for example, a speech model 130, in the simulation environment 100 and give positive and/or negative feedback when the dialog system 120 has performed what the user considers to be appropriate and/or inappropriate action(s). From the user feedback, the dialog system 120 learns to take actions, action sequences and/or action types and the like customized for the particular user, the utilities for which are adjusted in a utility model 150.

Accordingly, speaker-dependent adaptation can be extended to the dialog level by performing MLLR adaptation simultaneously with dialog personalization. Similar to MLLR adaptation, user(s) can end training at any time with the notion that the more they train, the more customized the dialog system 120 becomes. Unlike conventional MLLR adaptation; however, users are immediately able to observe how their feedback has caused the dialog system 120 to adapt, and can quit training whenever they feel that the dialog system 120 has adapted enough for current purposes.

As noted previously, human-computer dialog is an interactive process in which the dialog system 120 attempts to collect information from a user and respond appropriately. For example, suppose that an individual desires to have a command-and-control voice interface for navigating the web (e.g., due to physical limitations and/or disabilities). As discussed above, speech engines usually come shipped with speaker-independent model(s), as opposed to speaker-dependent, or personalized, models. Conventional wizards exist to use MLLR adaptation to train the acoustic and pronunciation models of a speech engine for a particular voice. However, that training only improves recognition of words; it does not improve the interaction.

With the simulation environment 100, a user can improve both the interaction and speech recognition by giving feedback about the appropriateness of actions taken by the dialog system 120 while at the same time allowing the system to collect sound samples for MLLR adaptation. Thus, with the simulation environment 100, in addition to training a speaker-dependent MLLR model (e.g., speech model 130) for recognition, a user can train the dialog system 120 to take better dialog actions and recognize utterances better for a particular dialog domain.

In the example of FIG. 1, the simulation environment 100 employs a dialog system 120 (e.g., baseline model) that utilizes parametric models (e.g., statistical model with learnable parameters such as a Bayesian network) and a language model 140 specifying all the utterances that can be spoken in the domain. A user interface component 110 samples an utterance from the language model 140 and presents it to the user (e.g., via a display). The user's task is to read the utterance. Optionally, the user interface component 110 can introduce noise as the user reads the utterance (e.g., for training purposes).

After the user reads the utterance, the dialog system 120 attempts to recognize what was said and respond accordingly. When the dialog system 120 responds, the user can give positive or negative feedback which can be used to update utilities in the utility model 150. For example, if the dialog system 120 responds by requesting “Can you repeat that?” and the user dislikes these kinds of “dialog repair” actions, the user can give negative feedback to the dialog system 120, for example, in the form of a virtual “shock” or buzz of varying intensity depending on the interface design in the user interface component 110.

In the simulation environment 100, once the dialog system 120 either receives negative feedback or positive feedback (explicit or implicit), when an end dialog state has been reached, the dialog system 120 can view the correct answer(s) via the user interface component 110. By observing the correct answer(s), the dialog system 120 can build case data for supervised learning of the form: “User said X. I heard Y with features P, Q, and R.” The speech model 130 (e.g., parametric models) underlying the dialog system 120 can update their parameters with the learning data.

Furthermore, when positive or negative feedback is received, the dialog system 120 receives an “experience tuple” of the form: “In state X, I took action A and received feedback F, and then entered state Y”. This information can be used to update the utilities in the utility model 150 and the parameters of the speech model 130 via the utility model 150. Finally, since the user is simply reading what is presented to the user (e.g., on the display), the dialog system 120 can record the utterance as a labeled sound sample for use in MLLR adaptation.

As the user continues to interact with the dialog system 120 in the simulation environment 100, more and more data cases can be used for supervised learning, reinforcement learning, and MLLR adaptation. The user can continue to train the dialog system 120 however long they wish knowing that the more they train, the more customized the dialog system 120 will be to the user. In other words, they can personalize the dialog system 120 to achieve speaker-dependent performance at both the recognition level and dialog level.

It is to be appreciated that the simulation environment 100, the adaptation component 110, the dialog system 120, the speech model 130, the language model 140 and the learning component 150 can be computer components as that term is defined herein.

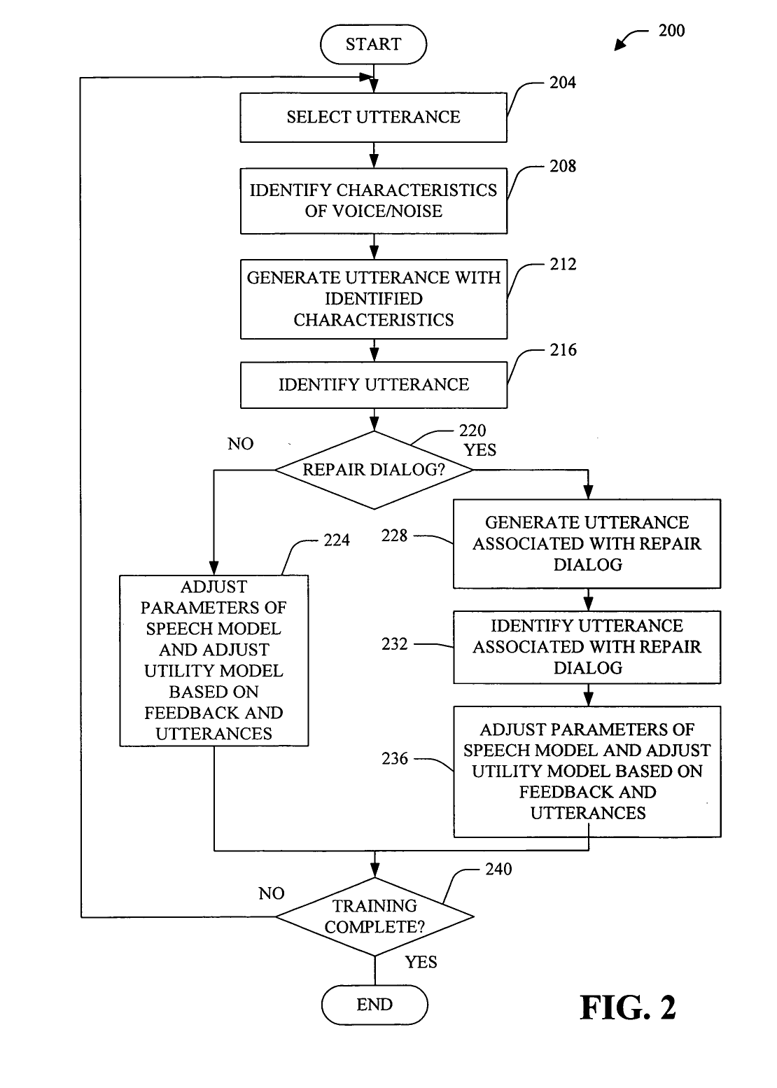

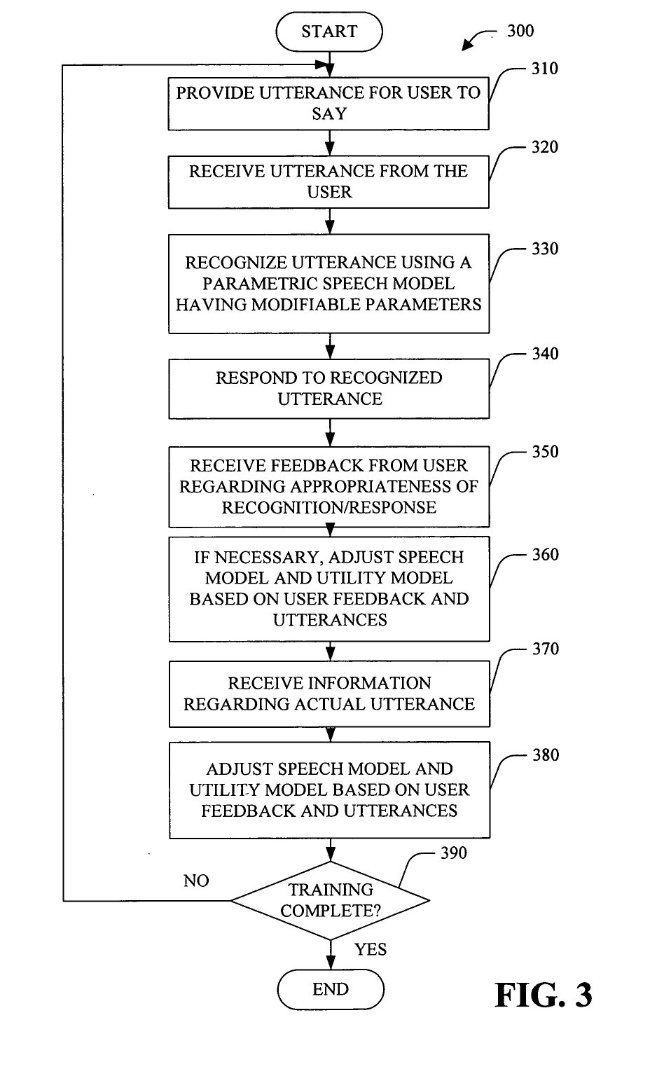

Turning briefly to FIGS. 2-3, methodologies that may be implemented in accordance with the claimed subject matter are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies.

The claimed subject matter may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Turning next to FIG. 2, a method of training an online reinforcement learning system is illustrated. At 204, an utterance is selected, for example, randomly by a model trainer 630 from a language model 620. At 208, characteristics of a voice and/or noise are identified. At 212, the utterance is generated with the identified characteristics, for example by a user simulator 610.

At 216, the utterance is identified, for example, by a dialog system 400. At 220, a determination is made as to whether a repair dialog has been selected. If the determination at 220 is NO, at 224, parameters of a speech model are adjusted based on feedback and utterances (e.g., the identified utterance and the utterance). Further, the utility model can be adjusted based on the feedback and utterances, and, processing continues at 240.

If the determination at 220 is YES, at 228, an utterance associated with the repair dialog is generated. At 232, an utterance associated with the repair dialog is identified (e.g., by the dialog system 400). At 236, parameters of the speech model are modified based on feedback and utterances. Further the utility model can be adjusted based on the feedback and utterances.

At 240, a determination is made as to whether training is complete. If the determination at 240 is NO, processing continues at 204. If the determination at 240 is YES, no further processing occurs. While the method of FIG. 2 depicts a single repair dialog, those skilled in the art will recognize that a repair can lead to one or more additional repair cycles.

Next, referring to FIG. 3, a method of adapting a speech model to a user is illustrated. At 310, an utterance is provided for a user to say. For example, a user interface component 110 can provide the utterance from a language model 140 that comprises utterances that can be spoken in a particular domain. At 320, the utterance is received from the user (e.g., by the dialog system 120).

At 330, the utterance is received by the speech model (e.g., parametric model). At 340, the dialog system responds to the recognized utterance. At 350, feedback is received from the user regarding appropriateness of the utterance recognition/response.

At 360, if necessary, the speech model and/or a utility model are adjusted based on the user feedback and utterance. At 370, information regarding the actual utterance is received, for example, from the adaptation component 720. At 380, the speech model and/or the utility model are adjusted based on the utterance as recognized, the actual utterance and/or feedback. At 390, a determination is made as to whether training is complete. If the determination at 390 is NO, processing continues at 310. If the determination at 390 is YES, no further processing occurs. While the method of FIG. 3 depicts a single adaptation cycle, those skilled in the art will recognize that an adaptation cycle can lead to one or more additional cycles.

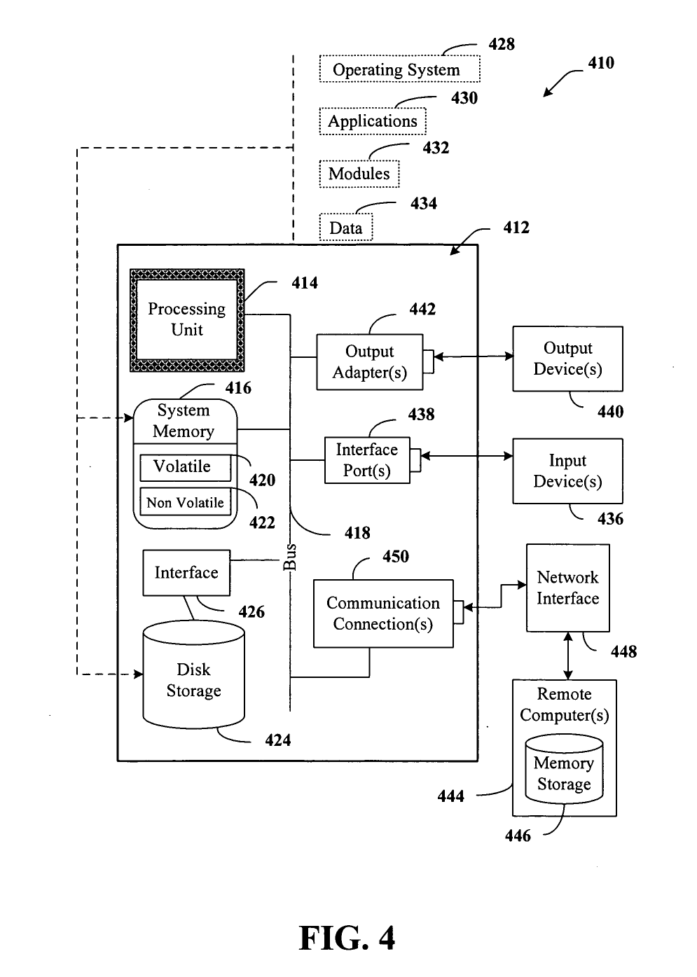

In order to provide additional context for various aspects of the claimed subject matter, FIG. 4 and the following discussion are intended to provide a brief, general description of a suitable operating environment 410. While the claimed subject matter is described in the general context of computer-executable instructions, such as program modules, executed by one or more computers or other devices, those skilled in the art will recognize that the claimed subject matter can also be implemented in combination with other program modules and/or as a combination of hardware and software. Generally, however, program modules include routines, programs, objects, components, data structures, etc. that perform particular tasks or implement particular data types. The operating environment 410 is only one example of a suitable operating environment and is not intended to suggest any limitation as to the scope of use or functionality of the claimed subject matter. Other well known computer systems, environments, and/or configurations that may be suitable for use with the claimed subject matter include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 4, an exemplary environment 410 includes a computer 412. The computer 412 includes a processing unit 414, a system memory 416, and a system bus 418. The system bus 418 couples system components including, but not limited to, the system memory 416 to the processing unit 414. The processing unit 414 can be any of various available processors. Dual microprocessors and other multiprocessor architectures also can be employed as the processing unit 414.

The system bus 418 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 416 includes volatile memory 420 and nonvolatile memory 422. The basic input/output system (BIOS), containing the basic routines to transfer information between elements within the computer 412, such as during start-up, is stored in nonvolatile memory 422. By way of illustration, and not limitation, nonvolatile memory 422 can include read only memory (ROM), programmable ROM (PROM), electrically programmable ROM (EPROM), electrically erasable ROM (EEPROM), or flash memory. Volatile memory 420 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 412 also includes removable/nonremovable, volatile/nonvolatile computer storage media. FIG. 4 illustrates, for example a disk storage 424. Disk storage 424 includes, but is not limited to, devices like a magnetic disk drive, floppy disk drive, tape drive, Jaz drive, Zip drive, LS-100 drive, flash memory card, or memory stick. In addition, disk storage 424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 424 to the system bus 418, a removable or non-removable interface is typically used such as interface 426.

It is to be appreciated that FIG. 4 describes software that acts as an intermediary between users and the basic computer resources described in suitable operating environment 410. Such software includes an operating system 428. Operating system 428, which can be stored on disk storage 424, acts to control and allocate resources of the computer system 412. System applications 430 take advantage of the management of resources by operating system 428 through program modules 432 and program data 434 stored either in system memory 416 or on disk storage 424. It is to be appreciated that the claimed subject matter can be implemented with various operating systems or combinations of operating systems.

A user enters commands or information into the computer 412 through input device(s) 436. Input devices 436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 414 through the system bus 418 via interface port(s) 438. Interface port(s) 438 include, for example, a serial port, a parallel port, a game port, and a universal serial bus (USB). Output device(s) 440 use some of the same type of ports as input device(s) 436. Thus, for example, a USB port may be used to provide input to computer 412, and to output information from computer 412 to an output device 440. Output adapter 442 is provided to illustrate that there are some output devices 440 like monitors, speakers, and printers among other output devices 440 that require special adapters. The output adapters 442 include, by way of illustration and not limitation, video and sound cards that provide a means of connection between the output device 440 and the system bus 418. It should be noted that other devices and/or systems of devices provide both input and output capabilities such as remote computer(s) 444.

Computer 412 can operate in a networked environment using logical connections to one or more remote computers, such as remote computer(s) 444. The remote computer(s) 444 can be a personal computer, a server, a router, a network PC, a workstation, a microprocessor based appliance, a peer device or other common network node and the like, and typically includes many or all of the elements described relative to computer 412. For purposes of brevity, only a memory storage device 446 is illustrated with remote computer(s) 444. Remote computer(s) 444 is logically connected to computer 412 through a network interface 448 and then physically connected via communication connection 450. Network interface 448 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 450 refers to the hardware/software employed to connect the network interface 448 to the bus 418. While communication connection 450 is shown for illustrative clarity inside computer 412, it can also be external to computer 412. The hardware/software necessary for connection to the network interface 448 includes, for exemplary purposes only, internal and external technologies such as, modems including regular telephone grade modems, cable modems and DSL modems, ISDN adapters, and Ethernet cards.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A simulation environment facilitating adaptation of a speech model to a user comprising:
an user interface component that provides an utterance for the user to utter; and,
a dialog system that comprises:
a speech model having a plurality of modifiable parameters, the speech model receives the utterance from the user and recognizes the utterance; and,
a utility model that modifies the parameters of the speech model based upon feedback associated with a response to the recognized utterance and a utility of action(s), action sequence(s) and/or action type(s).

2. The environment of claim 1, employed repeatedly to adapt the speech model to the user.

3. The environment of claim 1 with maximum likelihood linear regression performed in order to modify the parameters on the parameters of the speech model from the data gathered from the environment.

4. A speech model trained by the simulation environment of claim 1.

5. The environment of claim 1, further comprising a language model that specifies the utterances associated with a particular domain, the utterance provided by the user interface component based on the utterances specified by the language model.

6. The environment of claim 1, the user interface component further simulates a noisy environment with respect to the utterance received by the dialog system.

7. The environment of claim 1, the utility model comprising an influence diagram.

8. The environment of claim 1, the utility model employs local distributions that are decision trees.

9. The environment of claim 1, the feedback depends on a design associated with the user interface component.

10. The environment of claim 1, the learning component further modifies the parameters of the speech model based upon the utterance received from the adaptation component.

11. A method of adapting a speech model to a user comprising:
receiving an utterance from the user;
recognizing the utterance using a speech model having modifiable parameters;
responding to the recognized utterance;
receiving feedback from the user regarding appropriateness of the response;
adjusting a utility model based on the feedback; and,
adjusting parameters of the speech model based on the feedback.

12. The method of claim 11 further comprising:
receiving information regarding the utterance;
adjusting parameters of the speech model based on the utterance and the recognize utterance.

13. The method of claim 11 performed iteratively in order to adapt the speech model to the user.

14. The method of claim 13, each iteration based on a different utterance, the utterances based on a language model that comprises utterances associated with a particular domain.

15. The method of claim 11, further comprising simultaneously simulating a noisy environment when the utterance is received from the user.

16. A computer readable medium having stored thereon computer executable instructions for carrying out the method of claim 11.

17. A computer readable medium having stored thereon computer executable instructions for the speech model adapted by the method of claim 11.

18. A simulation environment that facilitates adaptation of a speech model to a user comprising:
means for providing an utterance for a user to utter;
means for recognizing the utterance;
means for adjusting parameters of the means for recognizing the utterance based upon feedback associated with a response to the recognize utterance; and,
means for further adjusting parameters of the means for recognizing the utterance based upon maximum likelihood linear regression.

19. The simulation environment of claim 18, performed iteratively during a training session, each iteration based on a different utterance.

20. The simulation environment of claim 19, the utterances based on a language model that comprises utterances associated with a particular domain.
